(19) United States
(12) Patent Application Publication
(10) Pub. No.: US 2012/0190346 A1
(43) Pub. Date: Jul. 26, 2012

(54) APPARATUS, SYSTEM AND METHOD FOR PROVIDING AUGMENTED REALITY INTEGRATED INFORMATION

(75) Inventor: Woo-Jin KIM, Incheon (KR)

(73) Assignee: PANTECH CO., LTD., Seoul (KR)

(21) Appl. No.: 13/247,790

(22) Filed: Sep. 28, 2011

(30) Foreign Application Priority Data
Jan. 25, 2011 (KR) 10-2011-0007288

(51) Int. Cl. H04W 4/00; H04M 1/00

(52) U.S. Cl. 455/414.1; 455/556.1

(57) ABSTRACT

An apparatus to provide Augmented Reality (AR) integrated information, includes an image acquiring unit to acquire an image of AR code, and a data processing unit to analyze the AR code to produce AR data, extract an element associated with a category from the AR data, generate a search term based on the extraction and display the AR data and/or search data.

### CROSS-REFERENCE TO RELATED APPLICATION

This application claims priority from and the benefit under 35 U.S.C. §119(a) of Korean Patent Application No. 10-2011-0007288, filed on Jan. 25, 2011, which is incorporated by reference for all purposes as if fully set forth herein.

### BACKGROUND

1. Field

This disclosure relates to an apparatus, a method and a system for providing augmented reality integrated information, and more particularly, to an augmented reality integrated information providing technology for providing augmented reality data about an object together with additional search data.

2. Discussion of the Background

A smart phone is a mobile phone that offers various operations, including scheduler, fax and data communication functions, internet connection, and mobile operability. The smart phone has a feature allowing the installation and uninstallation of different types of applications.

In addition, the smart phone may connect to the internet over a wireless/wired network, or through various browsing programs, such as applications. In addition, an application may be built by implementing an interface suitable by the use of various applications. In addition, applications may be shared with other smart phones having the same or compatible operating system (OS).

The Smartphone applications may include applications that display or provide augmented reality (AR). AR is a technology providing a view of a real-world environment along with other information. The elements of the real-world environment may be augmented in real time. In order to provide an enhanced sense of the real world, the AR technology provides AR information by applying virtual reality technology to objects and places that are observed in a real world.

According to the AR technology implemented through a smart phone terminal, location related information is obtained by the terminal and the information is transmitted to a server. The server recognizes additional information corresponding to the location related information and transports the recognized information to the terminal. The terminal displays the received information onto an image of the real world.

An AR service may be implemented by use of a location detection system (such as a Global Positioning System), an accelerometer sensor, WIFI or the like. A terminal transmits coordinate information of the terminal's location to a server, receives AR data about the corresponding location and displays the received AR data at a specific position. The AR service according to the above-mentioned AR technology displays the received AR information on a specific position. Thus, AR technology does not provide other services more than the limited service described above.

### SUMMARY

Exemplary embodiments provide an apparatus, a method and a system for providing augmented reality integrated information. The augmented reality integration information may be any combination of augmented reality data, search results from searches based on the data or other specific information defined in an apparatus or mobile terminal for providing the augmented reality integrated information.

Additional features of the invention will be set forth in the description which follows, and in part will be apparent from the description, or may be learned by practice of the invention.

An exemplary embodiment provides an apparatus to display Augmented Reality (AR), including: an image acquiring unit to acquire AR code; and a data processing unit to analyze the AR code to produce AR data, to extract an element associated with a category from the AR data and to generate a search term based on a combination of the element and specific information.

An exemplary embodiment provides a method for providing Augmented Reality (AR) integrated information, including: acquiring an image of AR code; analyzing the AR code to produce AR data; extracting an element associated with a category from the AR data; and generating a search term to produce search data based on at least one of: the extracted element or specific information.

An exemplary embodiment provides a system to provide Augmented Reality (AR) integrated information service, including: an AR integrated information providing apparatus to acquire an image of AR code, to extract an element associated with a category from AR data of the AR code, and to generate a search term based on at least one of: the element and specific information; and an AR server to receive the AR code through a wired or a wireless network, extract the AR data from the AR code and transmit the AR data to the AR integrated information providing apparatus.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain aspects of the invention.

FIG. 1 is a block diagram of an apparatus to provide AR integrated information according to an exemplary embodiment.

FIG. 2 is a block diagram of a data processing unit according to an exemplary embodiment.

FIGS. 3A to 3C illustrate a method for providing AR integrated information according to an exemplary embodiment.

FIGS. 4A to 4C illustrate a method for providing AR integrated information according to an exemplary embodiment.

FIGS. 5A to 5C illustrate a method for providing AR integrated information according to an exemplary embodiment.

FIGS. 6A to 6C illustrate a method for providing AR integrated information according to an exemplary embodiment.

FIG. 7 is a flowchart f a method for providing AR integrated information according to an exemplary embodiment.

FIG. 8 illustrates a system of providing AR integrated information according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Hereinafter, examples will be described with reference to accompanying drawings in detail.

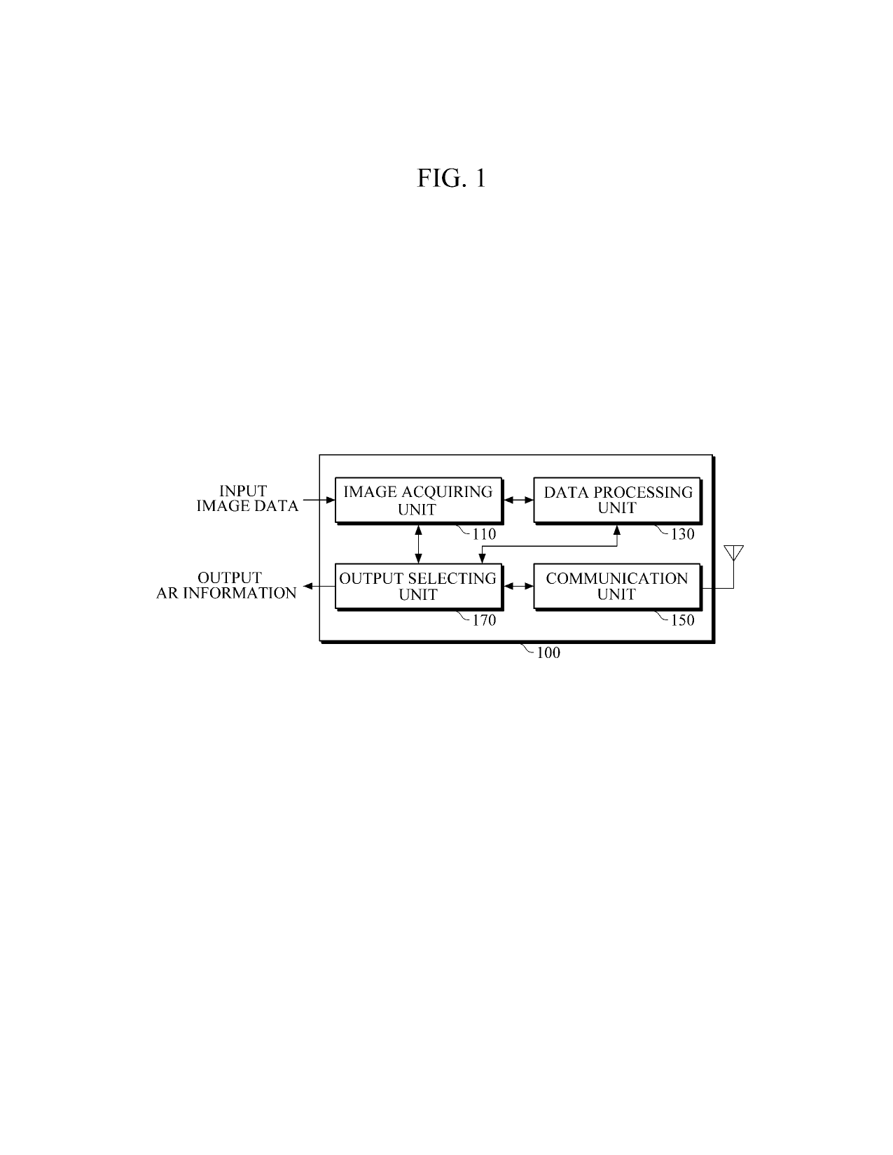

FIG. 1 is a block diagram of an apparatus to provide AR integrated information according to an exemplary embodiment.

Referring to FIG. 1, an augmented reality (AR) integrated information providing apparatus 100 includes an image acquiring unit 110, a data processing unit 130, a communication unit 150 and an output selecting unit 170. The image acquiring unit 110 includes at least a camera and/or an image sensor to acquire an image. The image may include an object and/or AR code. The AR code is a unique code that may be used to implement AR or identify AR information in a database. The image acquiring unit 110 outputs information obtained based on the acquired AR code information to the data processing unit 130.

The data processing unit 130 may be implemented using a processor capable of handling large amounts of data. The processor may be a multi-core processor; however, the processor is not limited hereto. The data processing unit 130 recognizes the AR code acquired from the image acquiring unit 110 to produce AR data, and transmits the AR data to a server (that may be external). The data processing unit 130 may also transmit to the server, location information and inclination information about the AR integrated information providing apparatus 100 along with the AR data.

The data processing unit 130 receives the AR data from the server. The received AR data includes information, such as a location and an angle of an object included in an image. The data processing unit 130 extracts elements associated with various categories from the received AR data. The element may be set as specific information or be included with the AR data. AR data in ARML (Augmented Reality Markup Language) includes defined categories, such as a tag, a description and a URL address.

The data processing unit 130 generates a search command based on a combination of the information corresponding to the extracted categories. For example, if the tag category has an element “(A) coffee”, the description category has an element “expensive but delicious”, and the URL address category has an element “www.ABC.com/124”, a search command may be generated by combining “(A) coffee” and “www.ABC.com/124”. Information corresponding to the generated search command may be acquired from a web server through wired/wireless internet communication networks, and transmitted to the AR integrated information providing apparatus 100.

The data processing unit 130 may use various combinations of the elements association with the categories. Thus, the data processing unit 130 may generate a search command by use of specific information set in advance in addition to the elements associated with various categories extracted from the AR code. For example, a search command may be generated by adding an element “purchase”, which may be of interest to a preference of a searcher, and search “purchase” combined with the extracted elements from the AR code, such as “(A) coffee” and “www.ABC.com/124”. Accordingly, search retrieves data information corresponding to purchase related information about “(A) coffee” through a server.

The information to be added may be set before or after the data processing unit 130 extracts elements based on the categories of the retrieved AR data.

The communication unit 150 performs data communication with at least one of an AR server and a search server. The communication unit 150 may be implemented using a communication module that performs a communication with server (which may be a server dedicated to AR), and specifically, may be a short range communication module such as a Bluetooth®, WI-FI® or Local Area Network (LAN) or a long range communication module, such as a satellite communication module. The communication unit 150 transmits an image, such as one recognized by the image acquiring unit 110, or AR code, that may have been recognized by the data processing unit 130, to a server through a network. After which, AR data is received through the communication unit 150 from the server. In addition, the communication unit 150 is connected to the data processing unit 130 and the output selecting unit 170.

The output selecting unit 170 controls the image acquiring unit 110 and the data processing unit 130 to display data of the data processing unit 130. The output selecting unit 170 outputs AR data and/or search data received through the communication unit 150. In addition, the output selecting unit 170 may allow extracted data and/or specific information to be displayed in the form of a list or an icon. The output selecting unit 170 may output the search data after outputting the AR data. Specific information refers to information that is sourced from a device prior or during the acquisition of an image of an AR code.

The AR integrated information providing apparatus 100 may be applied to various types of devices, including devices that display a three-dimensional image. For example, if the AR integrated information providing apparatus 100 is applied to a smart phone having a camera module and a display module, an image taken through the camera module and search information may be displayed on a display module by three-dimensional representation. In addition, the AR integrated information providing apparatus 100 may include a location detection module (such as a Global Position System (GPS) or the like) and an accelerometer sensor to acquire coordinate information of the AR integrated information providing apparatus 100 and angle information of the acquired object image.

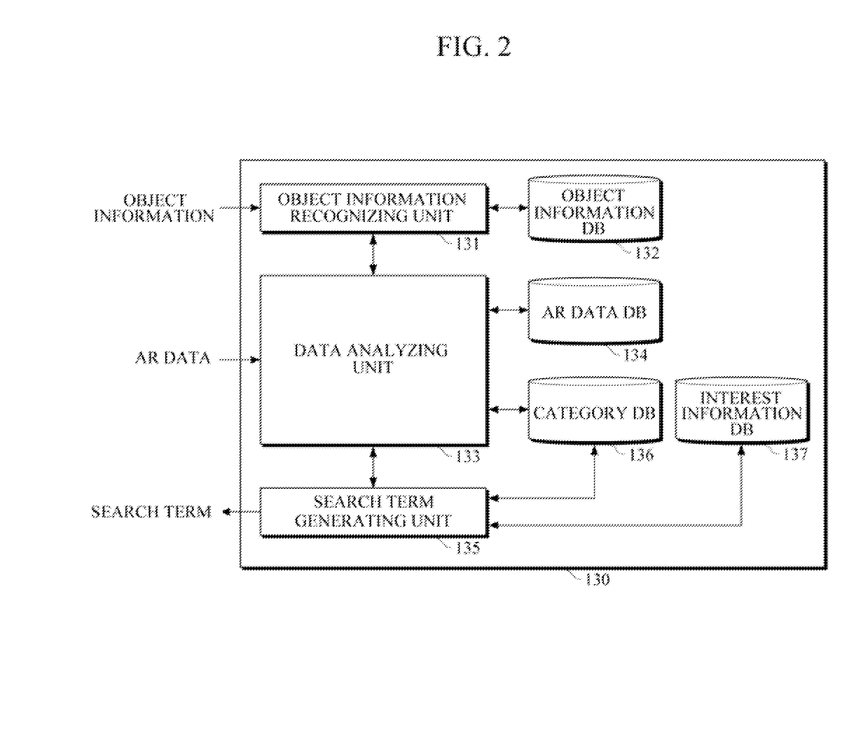

FIG. 2 is a block diagram of a data processing unit according to an exemplary embodiment.

Referring to FIG. 2, the data processing unit 130 may include an object information recognizing unit 131, an object information DB 132, a data analyzing unit 133, an AR data DB 134, a category DB 136, an interest information DB 137 and a search term generating unit 135. The object information recognizing unit 131 recognizes object information that may include an AR code of an object from an image acquired by the image acquiring unit 110. The object information recognizing unit 131 recognizes a unique code from an image of an object and sends a server (which may be an AR server) a request for AR data corresponding to the code. The object information recognizing unit 131 stores the recognized object information in the object information DB 132. Accordingly, if recognized object information is identical to the object information stored in the object information DB 132, the data processing unit 130 may provide AR data corresponding to the object information.

The data analyzing unit 133 stores AR data in the AR data DB 134. The data analyzing unit 133 analyzes elements associated with various categories of the AR data stored in the AR data DB 134. The data analyzing unit 133 may store the analyzed information in the category DB 136. Further, the data analyzing unit 133 may store the analyzed information in a server that communicates via the communication unit 150.

The data analyzing unit 133 may also include an element determination unit (not shown) and a category matching determination unit (not shown). The element determination unit determines whether the received AR data includes elements associated with various categories. As described above, the AR data may not include elements associated with various categories. The category matching determination unit determines whether the various categories of the AR data are matched to categories set in the AR integrated information providing apparatus 100. Further, the AR integrated information providing apparatus 100 may internally set the categories. If the various categories of the received AR data do not match the categories of the AR integrated information providing apparatus 100, the various categories of the received AR data may match categories internally set in the AR integrated information providing apparatus 100.

The term generating unit 135 generates a search term by extracting an AR data corresponding to the elements among the received AR data. The search term may be internet search information related to an object. That is, the AR integrated information providing apparatus 100 additionally provides internet search information related to an object in addition to an AR data that is normally provided.

If the determination of the element determination unit is that the AR data does not include elements associated with various categories, the search term generating unit 135 may extract specific information included in data stored in the AR integrated information providing apparatus 100, which added with the data extracted from the received AR data, to generate data for searching.

For example, if elements such as “A-105 TV”, “Korea-Seoul”, “product model produced in the first half year of 2010” and “ www.A-105.com” are extracted from the received AR data and the internal category includes “model name”, “manufacturer”, “specification” and “homepage address”, the element “A-105 TV” is classified into the category “model name”, the element “product model produced in the first half year of 2010” is classified into the category “specification” and the element “ www.A-105.com” is classified as the category “homepage address”. In this case, the search term generating unit 135 generates a search term by combining the respective elements of “A-105 TV”, “product model produced in the first half year of 2010” and “ www.A-105.com” with a category based on interest.

If the determination result of the element determination unit determines that the AR data does not include elements associated with various categories, the search term generating unit 135 may generate a search term by use of specific information included in data stored in a server that communicates via the communication unit 150. In addition, if the determination result of the element information determination unit is that the AR data does not include elements associated with various categories, the search term generating unit 135 may generate a search term by giving a priority to elements based on AR data previously stored in the AR integrated information providing apparatus 100.

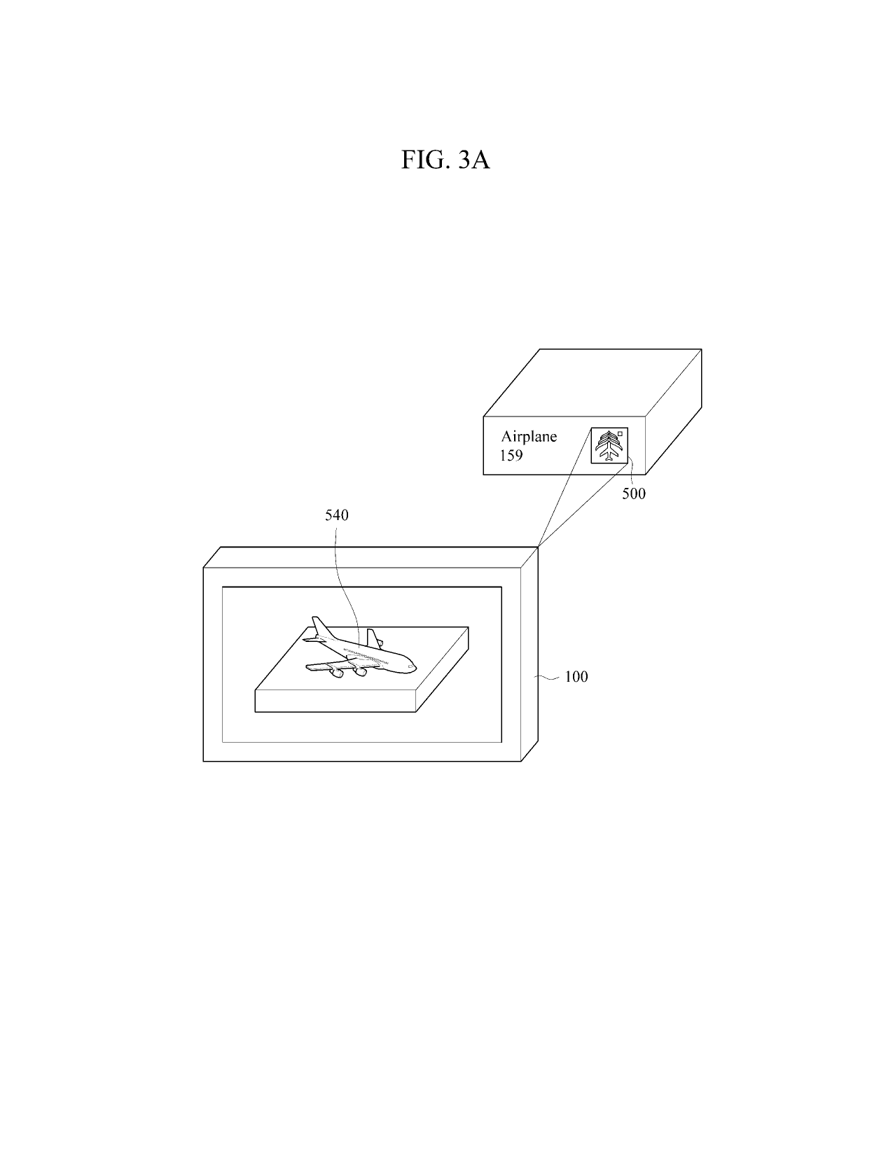

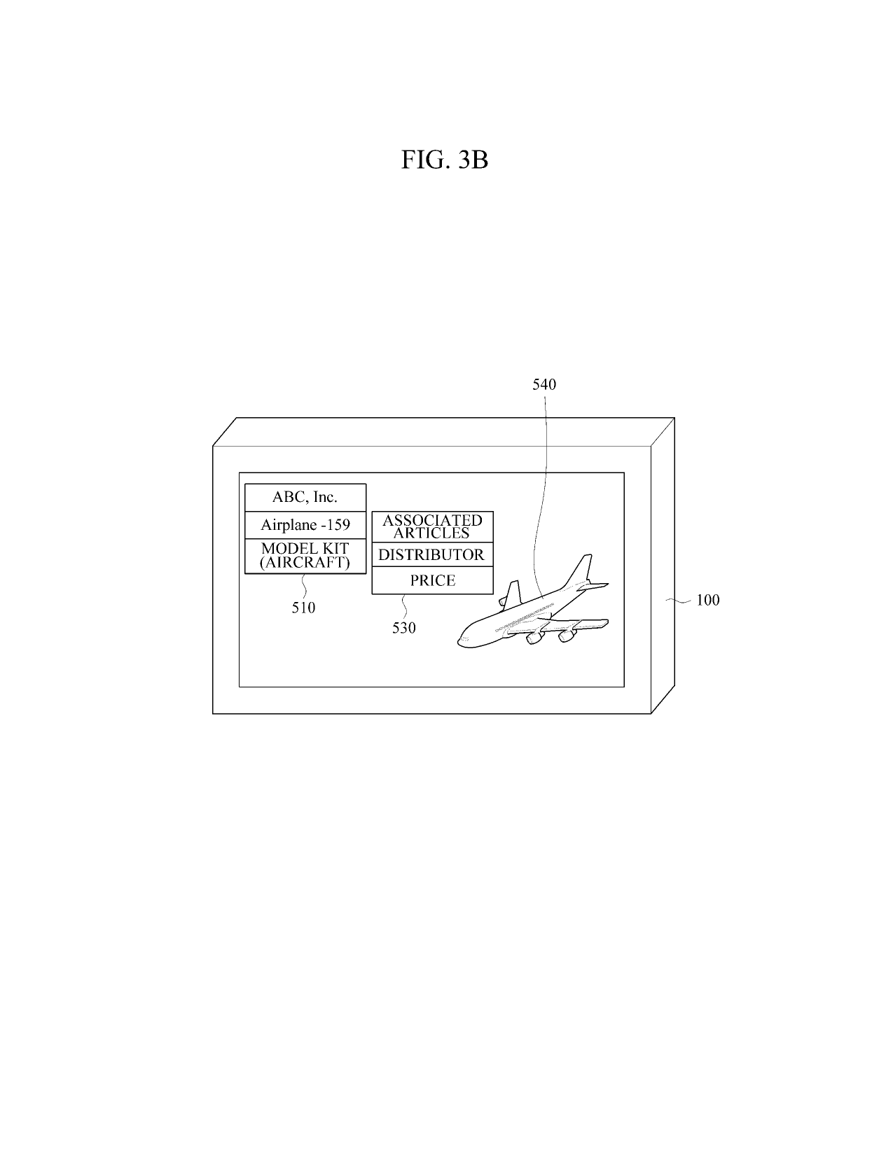

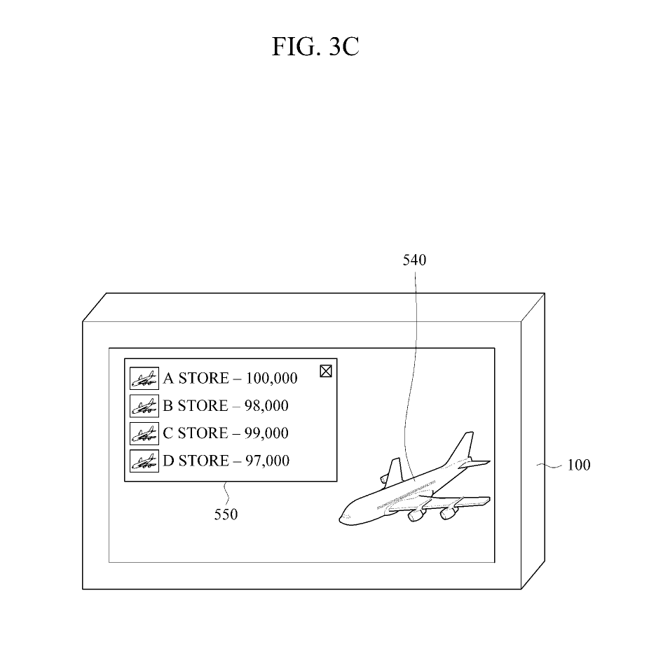

FIGS. 3A to 3C illustrate a method for providing AR integrated information according to an exemplary embodiment.

Referring to FIG. 3A, a wrapping box of a model kit has an AR code 500 corresponding to a product, i.e. the model kit. If the AR code 500 is recognized by the AR integrated information providing apparatus 100, a virtual image of an assembled aircraft model is displayed of the AR integrated information providing apparatus 100.

Referring to FIG. 3B, elements associated with various categories that are generated through analyzing the AR code 500 of the model kit is provided. The assembled aircraft virtual image 540 corresponding to AR data is displayed on the AR integrated information providing apparatus 100. An extracted category 510 is displayed, and includes a manufacturer, a name and a description of the product. Element “ABC, Inc.” is classified into the manufacture category, element “Airplane-159” is classified into the product name category, and element “model kit (aircraft)” is classified into the description category.

If additional information is required about the corresponding product, an additional search term may be generated. For example, if the price of the product model is desired to be known, a product name from the product category and a price category is selected, as shown in an interest information category 530 on the display. The items included in the interest information category 530 may be set in advance, and/or changed in real time. In addition, if a selection of an element associated with the product category is made, the interest information category 530 may be generated in conjunction with the selection.

Thus, the element “Airplane-159” and the element “price” are combined, generating a search term. The AR integrated information providing apparatus 100 transmits the generated search term to a server through the communication unit 150. The server used for the search may be set in advance and may be set by a user.

Referring to FIG. 3C, a search data 550 corresponding to the search term is displayed along with the assembled aircraft virtual image 540 on the AR integrated information providing apparatus 100. Price comparison and price checking may be performed based on various stores that maintain an inventory of the product searched. In addition, the search data 550 may further include a homepage link information of on/off line distributors selling the corresponding product, so that the cheapest price of a product may be achieved instantaneously or quicker. Thus, by receiving the search data 550, more information about a product may be received.

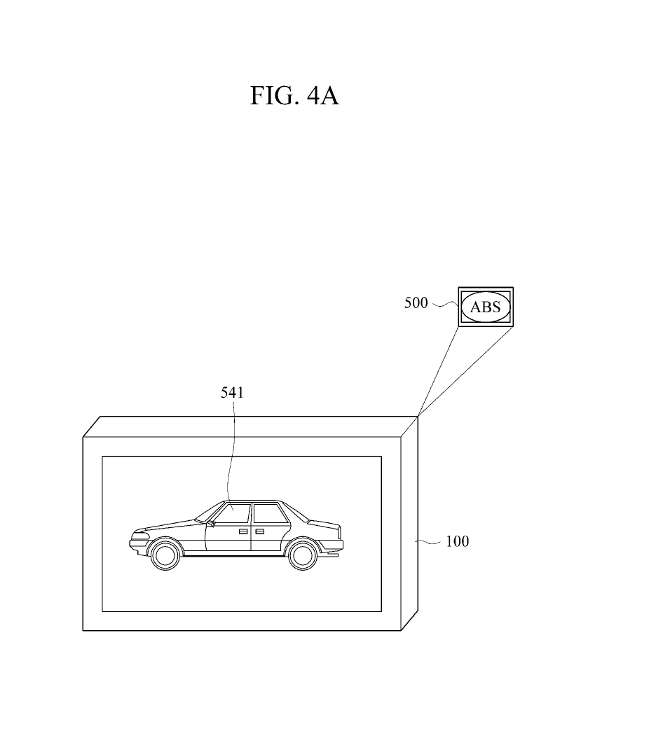

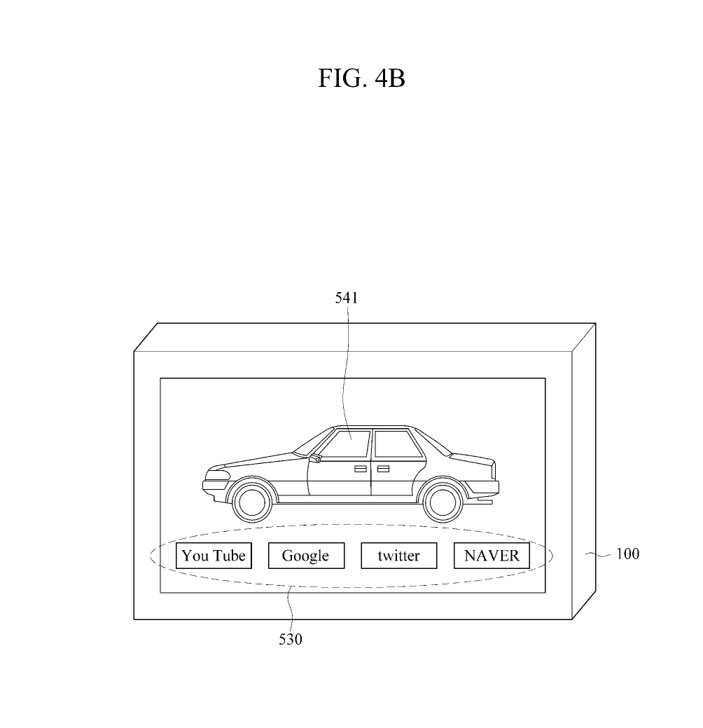

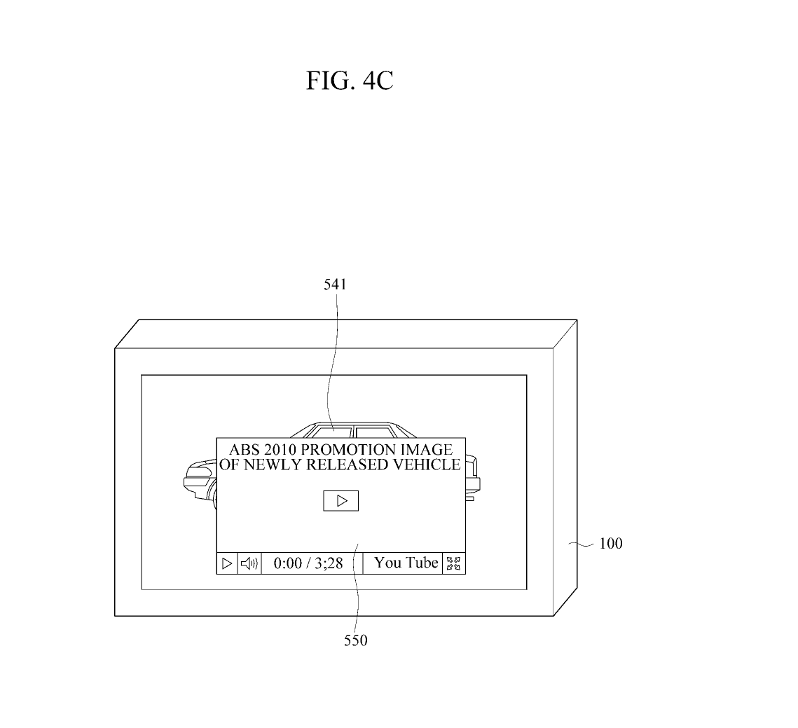

FIGS. 4A to 4C illustrate a method for providing AR integrated information according to an exemplary embodiment.

Referring to FIG. 4A, an image of AR code 500 of a vehicle is acquired by use of the AR integrated information providing apparatus 100. A virtual image 541 of a vehicle model corresponding to the AR code 500 is displayed on the AR integrated information providing apparatus 100. The virtual image 541 of the model may be changed according to a release date. Front/rear sides, left/right sides and upper/lower sides of the model may be displayed according to a horizontal rotation, a vertical rotation or an operation performed on the AR integrated information providing apparatus 100.

Referring to FIG. 4B, available web site elements are displayed as icons as the interest information category 530 in addition to the AR data. The icons may correspond to a link of an internet search engine site, a link of a moving picture providing site and a link of a social network site. The shapes of the icons, the order of arranging icons, the positions of the icons and the linked web page addresses may vary depending on the setting. For example, if “newly released vehicle”, “ABC-vehicle” and “advertisement” are extracted from AR data, “newly released vehicle” and “ABC-vehicle” except for “advertisement” may be selected along with “moving picture providing site” from the interest information category 530, thereby generating a search term.

Referring to FIG. 4C, a moving picture is shown as search data 550, which corresponds to the search term. The AR integrated information providing apparatus 100 transmits the search term to a server of a moving picture search site through a communication unit and acquires the search data 550. A moving picture image showing the newly released vehicle model of the ABS company driving on a road or being demonstrated at a motor show may be the search data 550. Accordingly, the AR integrated information providing apparatus 100 obtains additional information by use of information of a real world in addition to obtaining virtual information.

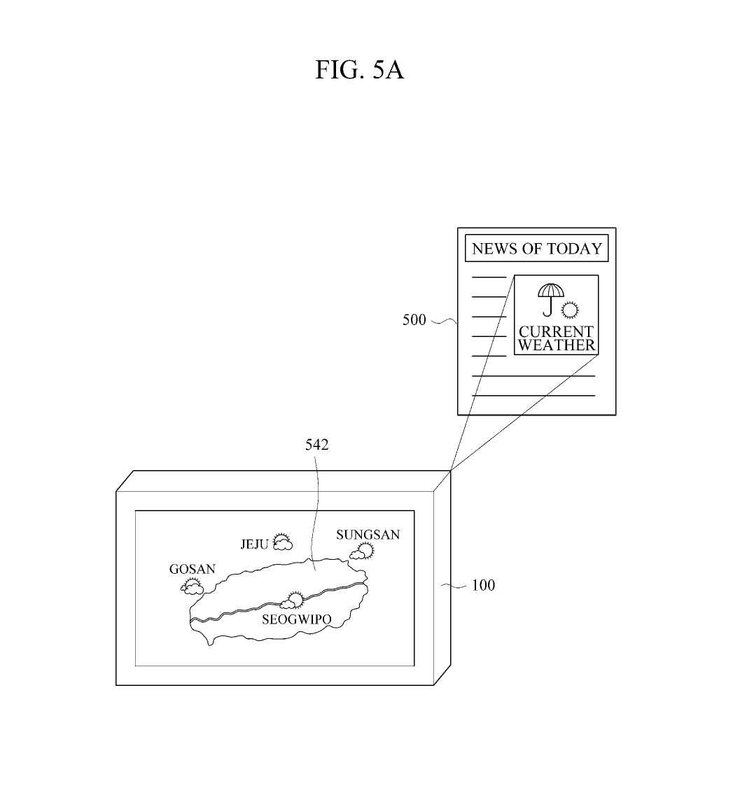

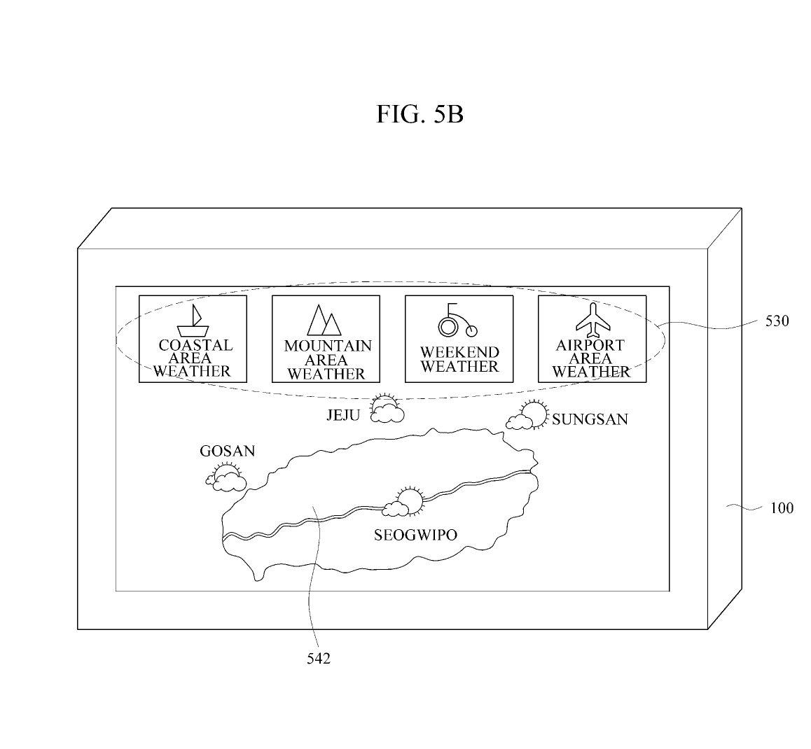

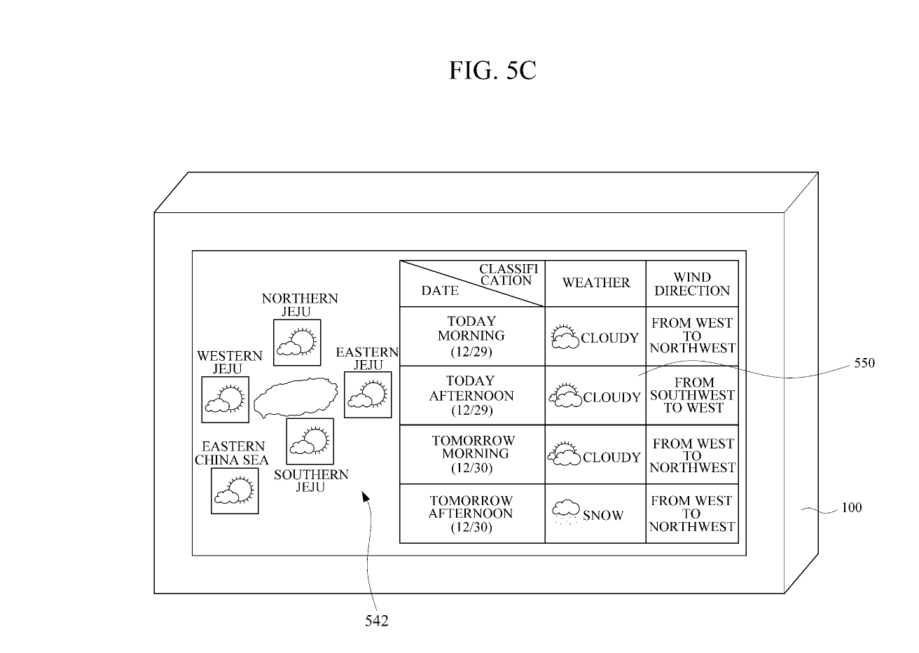

FIGS. 5A to 5C illustrate a method for providing AR integrated information according to an exemplary embodiment.

Referring to FIG. 5A, the AR code 500 about current weather is acquired by use of the AR integrated information providing apparatus 100. The AR integrated information providing apparatus 100 displays weather information 542 by use of current location information and/or the AR code 500. For example, weather information 542 about the Jeju Island may be received by use of a weather related AR code 500.

Referring to FIG. 5B, the AR integrated information providing apparatus 100 displays the interest information category 530 corresponding to search information additionally requested along with weather information 542. The interest information category 530 displays icons associated with categories, such as “coastal area weather”, “mountain area weather”, “weekend weather” and “airport area weather”. The category “coastal area weather” may be selected to learn the coastal area weather before going to the coastal area, for an activity such as saltwater fishing. If additional information about “coastal area weather” is selected, the AR integrated information providing apparatus 100 combines information about Jeju Island, information about the weather and information about the coastal area, thereby generating a search term. The generated search term is transmitted to a search server and the AR integrated information providing apparatus 100 receives the search data 550.

Referring to FIG. 5C, the AR integrated information providing apparatus 100 receives the search data 550 related to Jeju Island, weather and coastal area from the search server and displays the received search data 550. The search data 550 may be displayed instead of the AR data that is generally displayed, or may be displayed on the AR data in the form of a pop-up. As described above, detailed information in addition to weather information 542 may be received as part of the search data 550. Accordingly, the AR integrated information providing apparatus 100 displays more detailed information than merely the AR data, by displaying in addition to, or in place of the searched data.

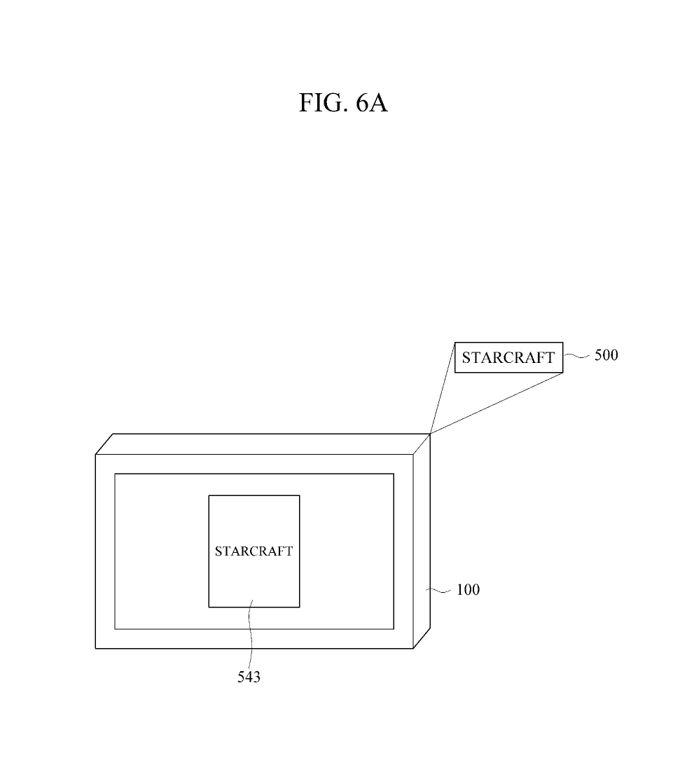

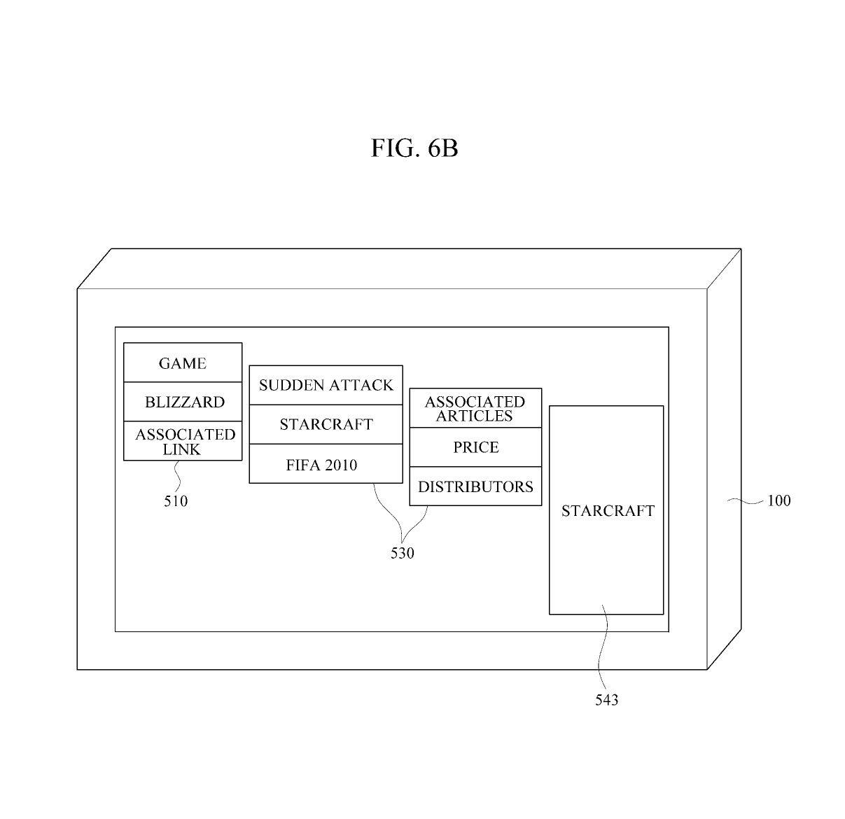

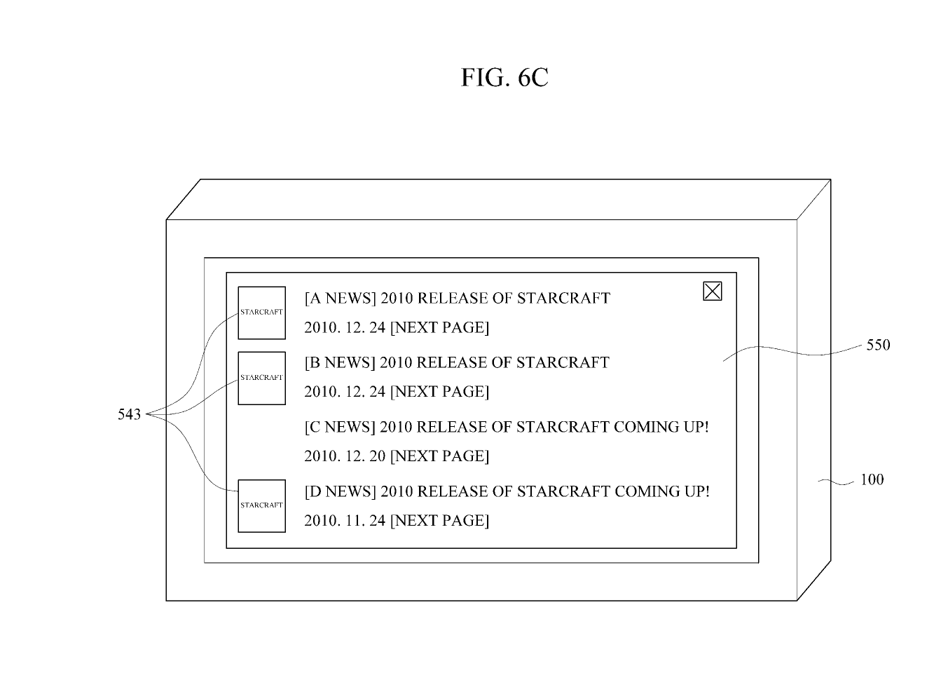

FIGS. 6A to 6C illustrate a method for providing AR integrated information according to an exemplary embodiment.

Referring to FIG. 6A, the AR code 500 is associated with a game, and is acquired by use of the AR integrated information providing apparatus 100. The AR code 500 may represent information that is encoded in the form of characters, images or the like. AR data 543 related to the corresponding game is displayed on the AR integrated information providing apparatus 100.

Referring to FIG. 6B, AR data 543 received from an AR server and a category list 510 that is extracted by analyzing the received AR data 543 are displayed. For example, if an AR data 543 of a game “StarCraft®” is analyzed, elements including “game”, “Blizzard®” and “associated link” are extracted. In this case, if the element “game” is selected, elements related to “game” may be executed, thereby showing elements of the selection in the interest information category 530. A priority on each element included in the interest information category 530 may be set.

For example, priorities of the elements including “Sudden Attack®”, “StarCraft®” and “FIFA2010®” in the order of “Sudden Attack®”, “StarCraft®” and “FIFA2010®” may be set. Accordingly, the information “Sudden Attack®” is displayed at the upper most place of the interest information category 530. If element “StarCraft®” is selected in the interest information category 530, a list of additional information including “associated articles”, “price” and “distributor” is displayed. If element “associated articles” is selected, a search term related to the element “associated articles” is generated and transmitted to a search server.

FIG. 6C shows a search data transported from the search server. A search term is generated based on the elements “game”, “StarCraft” and “associated articles” being selected, and search data 550 is generated and includes a search result about articles associated with the game “StarCraft”. The associated articles are sorted in the order of the earliest date, and each includes associated link information. An article may be selected, with details about the article being obtained through the link information. Accordingly, customized information in addition to the limited information may be acquired based on the AR code 500.

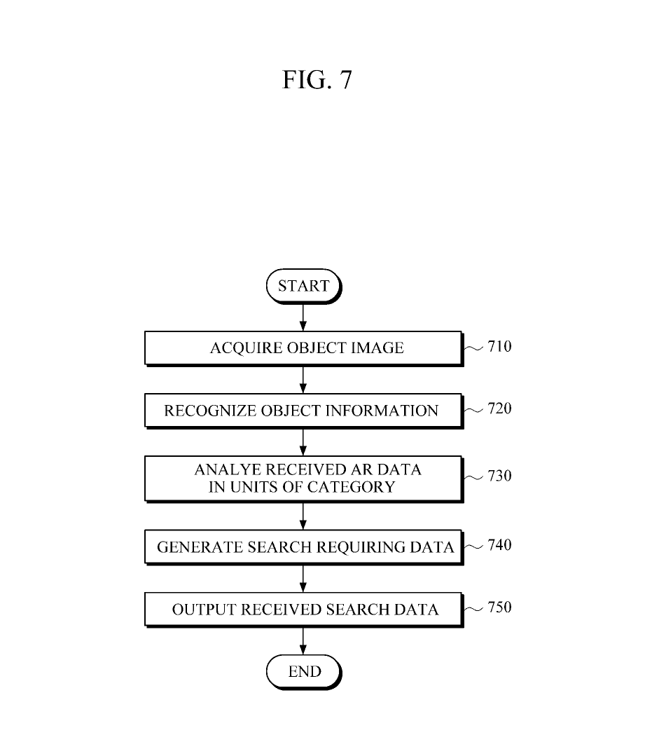

FIG. 7 is a flowchart of a method for providing AR integrated information according to an exemplary embodiment.

Referring to FIG. 7, an image of an object including an AR code is acquired (710). The AR code may include a bar code, a Quick Response (QR) code, and is implemented by encoding unique information by use of characters, symbols and images. Thereafter, the AR code is recognized from the image of the object (720). Information obtained by recognizing the AR code included in the object image is transmitted to the AR server. AR data corresponding to the object is received from the AR server, and categories that may exist in the AR data are extracted (730). In this case, the received AR data may not include elements associated with categories. If the received AR data does not include elements associated with categories, various categories about the extracted data may be set.

A search term is generated by use of the extracted data and additional information that may be entered (740). The search term may be generated by combining various elements in different combinations of the extracted data. The additional information may or may not be added to generating the search term. The generated search term is transmitted to a search server, and a search data corresponding to the search term is received. The search server may include a web server or an internet source connected to an internet network in addition to an AR server configured to provide an AR service.

Thereafter, the AR data and the search data received from the search server are displayed (750). The AR data may be output first and then search data corresponding to additional search information may be output together with the AR data. However, the display may be shown with the AR data and/or without the search data. Further, the search data is received before the AR data is displayed on the screen such that the AR data and the search data are simultaneously output on the screen.

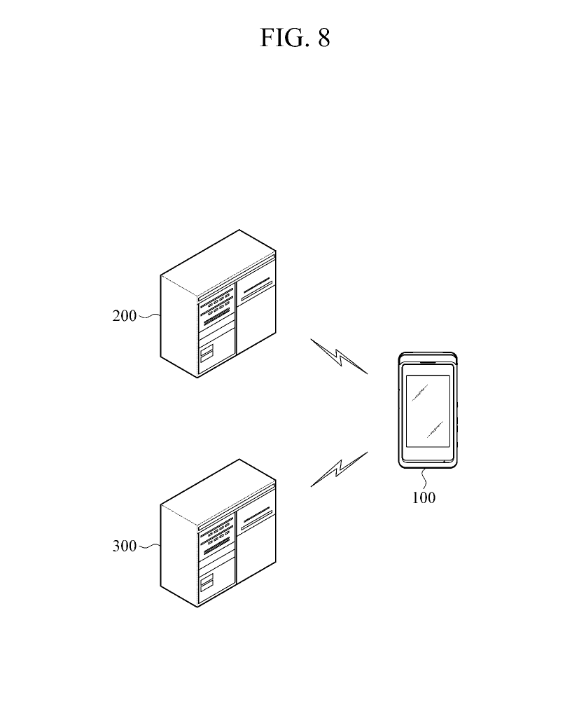

FIG. 8 illustrates a system of providing AR integrated information according to an exemplary embodiment.

Referring to FIG. 8, a system for providing AR integrated information includes the AR integrated information providing apparatus 100, an AR server 200 and a search server 300. The AR integrated information providing apparatus 100 may be mounted on a mobile phone and/or a tablet PC capable of executing applications. In addition, the AR integrated information providing apparatus 100 may perform a communication with a server through wired/wireless network. The AR server 200 receives an AR code from the AR integrated information providing apparatus 100, extracts AR data corresponding to the AR code and transmits the extracted AR data. One or more AR servers may be provided for each AR service.

The search server 300 is a server connected to an internet network and may include a web server for providing a search engine service, or a connection to a web server that does the same. Further, the search server 300 may include a server available for use in the AR integrated information providing system. The search server 300 analyzes a search term received from the AR integrated information providing apparatus 100 and extracts search data corresponding to the received data from an internal DB or a DB of another web server that is connected over the internet. The extracted data is transported to the AR integrated information providing apparatus 100 through a network. The extracted data may be displayed along with the AR data used to generate the search term.

The disclosure can also be embodied as non-transitory computer readable codes on a computer readable recording medium. The computer readable recording medium may be any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to display Augmented Reality (AR), the apparatus comprising:
an image acquiring unit to acquire an AR code; and
a data processing unit to analyze the AR code to produce AR data, to extract an element associated with a category from the AR data and to generate a search term based on a combination of the element and specific information.

2. The apparatus of claim 1, further comprising a communication unit to communicate with at least one of: an AR server and a search server.

3. The apparatus of claim 1, wherein the specific information is set before the element is extracted from the AR data.

4. The apparatus of claim 1, wherein the specific information is set after the element is extracted from the AR data.

5. The apparatus of claim 1, wherein additional information is received in real time, and combined with the element and the specific information to generate the search term.

6. The apparatus of claim 2, further comprising an output selecting unit to output at least one of the AR data and search data, wherein the search data is received via the communication unit.

7. The apparatus of claim 2, wherein the data processing unit comprises:
an object information recognition unit to recognize object information from the AR code;
a data analyzing unit to analyze the category of the element; and
a search term generating unit to generate the search term by extracting some or all of the AR data.

8. The apparatus of claim 6, wherein the output selecting unit outputs in the form of a list or an icon.

9. The apparatus of claim 6, wherein the output selecting unit outputs the search data.

10. The apparatus of claim 7, wherein the data analyzing unit stores the analyzed category in a category DB or a server via the communication unit.

11. The apparatus of claim 7, wherein the data analyzing unit comprises:
an element determination unit to determine whether the AR data includes elements associated with categories; and
a category information matching determination unit to determine whether the category is s matched to a defined category type.

12. The apparatus of claim 11, wherein if the AR data does not include elements associated with categories, the search term generating unit generates the search term based on the element.

13. The apparatus of claim 11, wherein if the AR data does not include elements associated with categories, the search term generating unit generates the search term based on data stored in the server.

14. The apparatus of claim 3, wherein the search term generating unit assigns a priority to the element.

15. A method for providing Augmented Reality (AR) integrated information, the method comprising:
acquiring an image of an AR code;
analyzing the AR code to produce AR data;
extracting an element associated with a category from the AR data; and
generating a search term to produce search data based on at least one of: the extracted element or specific information.

16. The method of claim 15, further comprising:
recognizing object information from the AR code;
analyzing a correspondence between the recognized object information and the extracted element; and
generating the search term to produce search data based on at least one of: the extracted element, the specific information or additional information.

17. The method of claim 16, further comprising:
determining whether the AR data includes categories; and
determining whether the category is a defined category type.

18. The method of claim 15, further comprising:
outputting at least one of: the AR data and the search data.

19. A system to provide Augmented Reality (AR) integrated information service, the system comprising:
an AR integrated information providing apparatus to acquire an image of an AR code, to extract an element associated with a category from AR data of the AR code, and to generate a search term based on at least one of: the element and specific information; and
an AR server to receive the AR code through a wired or a wireless network, extract the AR data from the AR code and transmit the AR data to the AR integrated information providing apparatus.

20. The system of 19, further comprising a search server to receive the search term from the AR integrated information providing apparatus, to produce search data corresponding to the search term data, and to transmit the search data to the AR integrated information providing apparatus.
